(19) United States
(12) Patent Application Publication
(10) Pub. No.: US 2024/0056295 A1
(43) Pub. Date: Feb. 15, 2024

(54) VERIFIABLE REMOTE RESOURCE MANAGEMENT FOR CRYPTOGRAPHIC DEVICES

(71) Applicant: Cryptography Research, Inc., San Jose, CA (US)

(72) Inventors: Mark Evan Marson, Carlsbad, CA (US); Thi Nguyen, San Jose, CA (US); Matthew Evan Orzen, San Francisco, CA (US)

(21) Appl. No.: 18/229,328

(22) Filed: Aug. 2, 2023

Related U.S. Application Data
(60) Provisional application No. 63/396,456, filed on Aug. 9, 2022.

(51) Int. Cl. H04L 9/08; G06F 8/65

(52) U.S. Cl. CPC H04L 9/088; G06F 8/65

(57) ABSTRACT

Aspects of the present disclosure involve a method, a system and a computer readable memory to perform a secure update of a target device, including communicating an update instruction to the target device, generating one or more data values using the update instruction, generating a first authentication value using the data value(s), receiving a second authentication value from the target device, wherein the second authentication value is generated by the target device in response to the update instruction, and determining whether the secure update has been successful based on a comparison of the first authentication value and the second authentication value.

### RELATED APPLICATIONS

This application claims the benefit of priority from U.S. Provisional Application No. 63/396,456, filed on Aug. 9, 2022, which is incorporated herein by reference.

### TECHNICAL FIELD

Aspects of the present disclosure are directed to improving efficiency and security of cryptographic operations. More specifically, aspects of the present disclosure are directed to management of cryptographic protection of computing devices.

### BRIEF DESCRIPTION OF THE DRAWINGS

The present disclosure will be understood more fully from the detailed description given below and from the accompanying drawings of various implementations of the disclosure.

FIG. 1 illustrates an example network architecture in which various implementations of the present disclosure may operate.

FIG. 2A depicts example operations of a verifiable remote secure update, performed in accordance with one or more aspects of the present disclosure.

FIG. 2B depicts example operations of a verifiable remote secure update, performed over a secure communication channel, in accordance with one or more aspects of the present disclosure.

FIG. 3 depicts a flow diagram of an example method of initiating a remote secure update and verifying successful completion of the remote secure update, in accordance with one or more aspects of the present disclosure.

FIG. 4 depicts a flow diagram of an example method of performing a secure update based on instruction from a remote device, in accordance with one or more aspects of the present disclosure.

FIG. 5 depicts a block diagram of an example computer system operating in accordance with one or more aspects of the present disclosure.

### DETAILED DESCRIPTION

Management of cryptographic protection of computing devices may entail operations that involve changing a cryptographic state of a device externally, e.g., by a service that manages cryptographic protection of data on the device. Such changes may include generating new cryptographic keys, performing a secure update of cryptographic applications installed on the device, installing new software, removing previously installed software, changing access rights of users/applications of the device, decommissioning the device (e.g., clearing the device from sensitive information stored thereon), and the like. Verifying that appropriate updates have been successfully and properly executed typically requires physical access to the device. This increases time, costs, and the need for additional logistical support.

Aspects and implementations of the present disclosure address these and other challenges of the existing technology by enabling systems and techniques for remote management of cryptographic devices. The disclosed remote management techniques allow verifying that various secret resources, such as cryptographic keys and other sensitive information, are appropriately modified and/or removed in the course of a secure update. In some implementations, a server (herein referred to as an update server or server machine) that performs a secure update or decommissioning of a target device may be aware about the existence of sensitive data on the target device, though not necessarily cognizant of the actual values of that sensitive data. Both the update server and the target device may have software or firmware capable of performing coordinated actions to execute a secure update. In one example, the update server may generate an update session key, e.g., a symmetric key, encrypt the update session key (e.g., with a public key of the target device), and communicate the encrypted update session key to the target device. The symmetric key may be used by the update server to encrypt an update instruction and by the target device to decrypt the update instruction. The update instruction may identify specific data, keys, and other digital values stored on the target device that are to be replaced with new data, keys, etc. Some of the information in the update instruction (e.g., new binary files to install the updates) may be included in the update instruction in the explicit form. Other information in the update instruction may be included in an implicit form. For example, the update instruction may include a seed value that may be used by a pseudorandom generator to generate any number of cryptographic keys (and/or other data values) that may be used to replace the existing keys (and/or other data values) stored on the target device.

The target device may install the update, including replacing some or all sensitive data values (e.g., cryptographic keys) using the seed value. In some implementations, the secure update may be a decommissioning operation that replaces some or all cryptographic keys or other security-sensitive values with dummy values. After the replacement values have been stored in the memory of the target device, the software/firmware performing the update may retrieve the replacement values from the memory (e.g., by performing a memory read operation). The update process may include computing one or more authentication values (codes, tags, etc.) using the retrieved data values. The authentication code may jointly depend on multiple data values, such that a change of even a single data value may cause a change of the authentication code. The authentication code may be computed using any known techniques. In one example, computing the authentication code may include multiplying a first replacement value by a hash value, adding a second replacement value to the resulting product, multiplying the result by the hash value, and so on, until the whole set of data values scheduled for verification has been processed. The obtained authentication value may be communicated to the update server. The update server may independently perform a similar process of generating the set of the data values (using the same seed value) and computing the authentication value (or multiple authentication values) for the set of the data values (using the same hash value). The update server may then compare the authentication value computed locally with the authentication value received from the target device. The matching of the two authentication values indicates then that the update (decommissioning) of the target device has been successful and that the right number of the correct data values have been stored on the target device. Numerous additional implementations are disclosed below. The advantages of the disclosed implementations include, but are not limited to, efficient execution of secure updates on remote target devices without physical access to those devices.

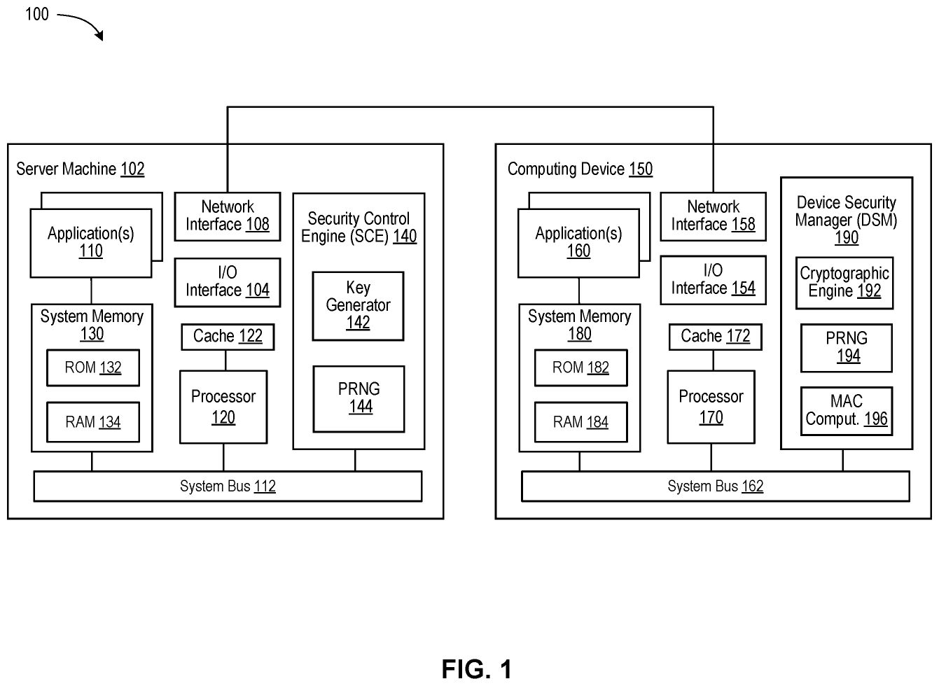

FIG. 1 illustrates an example network architecture 100 in which various implementations of the present disclosure may operate. As illustrated, network architecture 100 may include a server machine 102 (also referred to as the update server herein) that manages remote secure updates of a computing device 150 (also referred to as the target device herein). Server machine 102 and/or computing device 150 may be any desktop computer, a tablet, a smartphone, a rackmount server, a thin/lean client device, a server, a cloud computing node, and the like. In some implementations, server machine 102 may be any device of a service that provides cryptographic support to computing device 150. In some implementations, computing device 150 may include multiple devices, e.g., a local network of computing devices. In some implementations, computing device 150 may be an edge device or any device having limited computational resources, but operating in a security-sensitive domain, e.g., a network switch, a gateway device, a card reader, a wireless sensor node, an Internet-of-Things (IoT) node, an embedded system dedicated to one or more specific applications, and so on.

Server machine 102 may have one or more processors 120, e.g., CPUs, GPUs, field-programmable gate arrays (FPGA), application-specific integrated circuits (ASICs), and the like. “Processor” refers to a device capable of executing instructions encoding arithmetic, logical, or I/O operations. In one illustrative example, a processor may follow Von Neumann architectural model and may include one or more arithmetic logic units (ALUs), a control unit, and may further have access to a plurality of registers or a cache 122.

Server machine 102 may have access to one or more system memory 130 devices. The system memory 130 may refer to any volatile or non-volatile memory and may include a read-only memory (ROM) 132, a random-access memory (RAM) 134, as well as (not shown) electrically erasable programmable read-only memory (EEPROM), flash memory, flip-flop memory, or any other device capable of storing data. RAM 134 may be a dynamic random-access memory (DRAM), synchronous DRAM (SDRAM), a static memory, such as static random-access memory (SRAM), and the like. In some implementations, processor(s) 120 and the system memory 130 may be implemented as a single controller, e.g., as an FPGA.

Server machine 102 may further include an input/output (I/O) interface 104 to facilitate connection of server machine 102 to various peripheral hardware devices (not shown) such as card readers, terminals, printers, scanners, IoT devices, and the like. Server machine 102 may further include a network interface 108 to facilitate connection to a variety of networks, such as the Internet, wireless local area networks (WLAN), personal area networks (PAN), public networks, private networks, etc.). Network interface 108 may facilitate data transfers to/from computing device 150. Network interface 108 may include a radio front end module and other devices (amplifiers, digital-to-analog and analog-to-digital converters, dedicated logic units, etc.). Various hardware components of server machine 102 may be connected via a system bus 112 that may include its own logic circuits, e.g., a bus interface logic unit (not shown).

Server machine 102 may support one or more applications 110. Applications 110 may be applications supporting provisioning of cryptographic protection to computing device 150 and/or similar devices. Applications 110 may maintain a database of various cryptographic resources operating on computing device 150 (and any other client devices supported by server machine 102), as well as schedule installation, updates, and removal of such resources. Application(s) 110 may be instantiated directly on server machine 102 and supported by an operating system executed by the processor 120 and residing in the system memory 130. In some implementations, application(s) 110 or any resources used by application(s) 110 may be supported by a remote access infrastructure and may operate on a separate server (not shown in FIG. 1).

The processor 120 may include one or more processor cores having access to a single or multi-level cache 122 and one or more hardware registers. In some implementations, each processor core may execute instructions to run a number of hardware threads, also known as logical processors. Various logical processors (or processor cores) may be assigned to one or more application(s) 110, although more than one processor core (or a logical processor) may be assigned to a single application for parallel processing. A multi-core processor may simultaneously execute multiple instructions. A single-core processor may typically execute one instruction at a time (or process a single pipeline of instructions). The processor 120 may be implemented as a single integrated circuit, two or more integrated circuits, or may be a component of a multi-chip module.

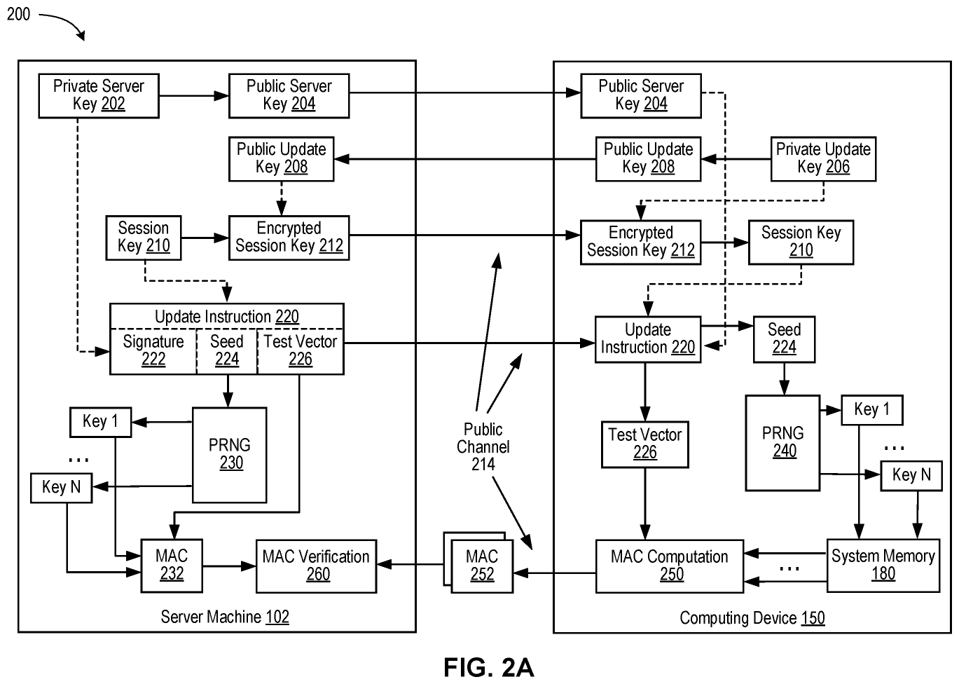

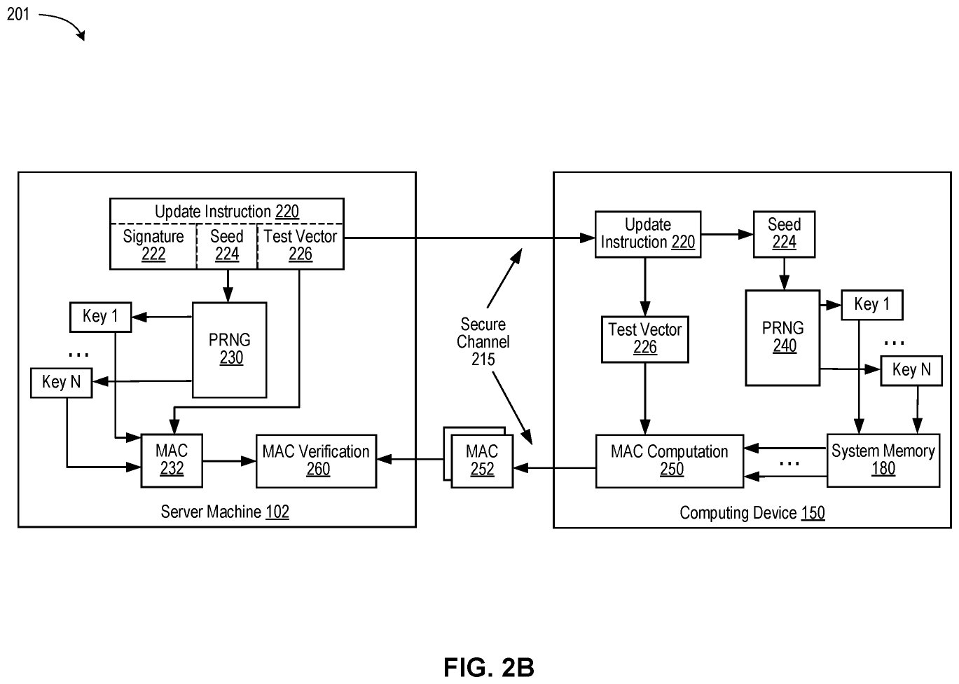

Server machine 102 may include a security control engine (SCE) 140, which may be a software/firmware module that manages security of computing device 150. Some operations of SCE 140 may be performed by a hardware circuit, cryptographic accelerator, or other similar devices. SCE 140 may perform various operations, as described in more detail in conjunction with FIG. 2A and FIG. 2B, including initiating secure updates, providing corresponding instructions to computing device 150, and verifying that the secure update has been successful. SCE 140 may include a key generation engine 142, which may use a pseudorandom number generator (PRNG) 144.

Computing device 150 may include one or more processors 170, fast cache 172, system memory 130 (e.g., ROM 182, RAM 184, etc.), I/O interface 154 (to connect various peripheral hardware devices), network interface 158, system bus 162, and other components. The function of various components of computing device 150 may be similar to the function of the corresponding components of server machine 102. Computing device 150 may support one or more applications 160. Applications 160 may include machine-learning application(s), graphics application(s), computational application(s), embedded application(s), external application(s), or any other types of application(s) that may be executed by computing device 150. A subset of applications 160 may be cryptographic application(s) that provide cryptographic support to at least some operations of computing device 150, including but not limited to cryptographic authentication, encryption, decryption, secure data storage, and the like. Applications 160 may operate in conjunction with at least some of applications 110 operating on server machine 102. Applications 160 may use various cryptographic resources, including but not limited to cryptographic engines (accelerators), symmetric and asymmetric ciphers, secure memory, and other devices.

Computing device 150 may include a device security manager (DSM) 190 that manages cryptographic protection of various applications 160 operating on computing device 150, authenticates users of computing device 150, maintains and enforces user and application access levels to various resources and programs of computing device 150, and the like. DSM 190 may perform various operations, as described in more detail in conjunction with FIG. 2A and FIG. 2B, including receiving secure update instructions from SCE 140 of server machine 102, performing the secure updates as instructed by SCE 140, replacing cryptographic keys and other secure data, and communicating back to SCE 140 various authentication values and other data that enables SCE 140 to verify whether the secure update has been successfully performed by DSM 190. While some of the operations of DSM 190 may be performed by software/firmware modules, in various implementations at least some operations of SCE 140 may be performed by a hardware circuit facilitating fast performance of secure updates. Operations of DSM 190 may be facilitated by a cryptographic engine 192, which may generate cryptographic keys, encode and decode data using various cryptographic algorithms, and so on. DSM 190 may further include a PRNG 194 and authentication data computation engine 196.

FIG. 2A depicts example operations 200 of a verifiable remote secure update, performed in accordance with one or more aspects of the present disclosure. Example operations 200 may include providing an update instruction from server machine 102 to computing device 150, performing the corresponding updates by computing device 150, and communicating authentication data back to server machine 102 to enable server machine 102 to verify that the correct secure update has been implemented by computing device 150. In some implementations, the secure update may be a complete decommissioning of computing device 150. More specifically, complete decommissioning may include overwriting cryptographic keys and any other sensitive data with arbitrary digital values having no significance, referred to as dummy data herein. The sensitive data may include passwords, user and applications identifiers, addresses, personal user data, access history, and any other confidential information. In some implementations, a secure update may include overwriting some (or all) cryptographic keys and other sensitive data with new valid cryptographic keys, installing a new software, adding a new user or an application, and the like. Operations of server machine 102 may be supported by SCE 140 and operations of computing device 150 may be supported by DSM 190 (as illustrated in FIG. 1). Communications from server machine 102 may be authenticated (e.g., digitally signed) with a private server key 202. Private server key 202 may be a part of a private/public pair of keys with a public server key 204 known (e.g., previously communicated, as shown by the corresponding solid arrow) to computing device 150.

In some implementations, computing device 150 may maintain a private/public key pair to be used in conjunction with secure updates, e.g., a private update key 206 and a public update key 208. Public update key 208 may be known (e.g., previously communicated, as shown by the corresponding solid arrow) to server machine 102. Public/private key pairs used by server machine 102 and/or computing device 150 may use any known public key infrastructure (PKI) algorithms, such as RSA (Rivest-Shamir-Adleman) algorithms, elliptic curve cryptographic algorithms, and so on. In some implementations, server machine 102 and computing device 150 may share respective public keys using Diffie-Hellman key exchange protocol or any other suitable algorithm. In some implementations, to perform a secure update, server machine 102 may generate a session key 210. In some implementations, session key 210 may be a one-time (ephemeral) key generated for the secure update session. In some implementations, session key 210 may be a symmetric key, generated using any appropriate encryption standard, e.g., an Advanced Encryption Standard (AES), the Data Encryption Standard (DES), Blowfish, various Rivest Ciphers (e.g., RC4, RC5, RC6), and the like.

Session key 210 may be encrypted with public update key 208. (In FIG. 2A and FIG. 2B, data flows are indicated with solid arrows and the use of cryptographic keys during encryption/decryption operations is indicated with dashed arrows.) The encrypted session key 212 may be communicated to computing device 150, e.g., over a public channel 214, which may be a part of any network connecting server machine 102 and computing device 150.

Session key 210 may be used to encrypt an update instruction 220. Update instruction 220 may include one or more messages prepared by server machine 102 and specifying the scope and/or the order of the update/decommissioning to be performed on computing device 150. For example, update instruction 220 may specify which resources of computing device 150 are to be removed and which resources are to be added to computing device 150. Update instruction 220 may specify which cryptographic keys (and/or any other secret data) are to be replaced. Update instruction 220 may include a digital signature 222 cryptographically signed with a private key of server machine 102, e.g., private server key 202. In some implementations, digital signature 222 may be signed with private server key 202 that is specific for computing device 150, such that each computing device managed by server machine 102 may have a separate assigned private server key 202.

Update instruction 220 may further include a seed value, also referred to as seed 224 herein. Seed 224 may be any nonce value generated (e.g., randomly or deterministically) for the update session. Seed 224 may be kept secret and used to generate a unique set of cryptographic keys and/or other secret data. Update instruction 220 may further include a test vector 226. Test vector 226 may be another unique (random or deterministic) nonce value used to generate an authentication value in the course of the update verification process, as described below. In some implementations, test vector 226 may be generated by a PRNG 230 (e.g., based on the same seed 224). In some implementations, test vector 226 is not communicated to computing device 150 and is generated locally on computing device 150 (e.g., based on seed 224). In some implementations multiple test vectors 226 may be included in update instruction 220, or generated locally on computing device 150, each test vector 226 to be used for the update verification of a different data value or a group of data values.

In addition to communicating seed 224 and test vector 226 to computing device 150, server machine 102 may use seed 224 and test vector 226 to perform the server part of the verification process. In particular, server machine 102 may use a PRNG 230 to generate digital data values whose number N may be the same as the number of the data values that is to be generated by the computing device 150. The data values may be generated by PRNG 230 using seed 224 to initialize the random sequence of data values. Depending on the specific random number-generating algorithm, PRNG 230 may use seed 224 in any suitable manner ensuring that a random-like sequence of values is produced, which can be recovered by another instance of random-number generation starting from the same seed 224. Although FIG. 2A shows, for brevity and ease of viewing, keys 1 . . . N being generated by PRNG 230, server machine 102 may also generate any other type of data, whose presence on computing device 150 following the completion of the update is to be verified. Such data may include new keys generated on computing device 150 and any other secret information, e.g., passwords, password hashes, etc. Such data may include dummy data to replace any secret information that is to be overwritten on computing device 150, e.g., keys, confidential logs, histories, settings, financial data, and/or any other information. Keys 1 . . . N may be 256-bit keys, 512-bit keys, 1024-bit keys, or keys of any other suitable length.

After generating keys 1 . . . N and/or any other replacement or new data values, server machine 102 may use the generated values to produce one or more authentication values, e.g., message authentication codes (MAC) 232. MAC 232 may be computed in a practically unlimited number of ways, such that a change in any one input value (or a change in the number of input values) modifies the output MAC. In one example implementation, MAC 232 may be computed using a suitable HMAC (Hash-Based Message Authentication Code) HMAC (key, message), e.g., HMAC-SHA-256, HMAC-SHA-512, and the like. For example, a data value (or any number of multiple, e.g., concatenated, data values, or their cryptographic hashes) being verified may be used as a key argument of HMAC and test vector 226 may be used as a message argument of HMAC. In some implementations, a data value (or any number of multiple, e.g., concatenated, data values, or cryptographic hashes of the data values) being verified may be used as the message argument of HMAC and session key 210 may be used as the key argument. Numerous other combinations of data values with various other values shared between server machine 102 and computing device 150 may be used as key and/or message of HMAC. Any number (e.g., one, two, etc., up to the total number of data values being verified) of MACs 232 may be generated by computing device 150 using HMAC an communicated to server machine 102.

In some implementations, a hash value H is multiplied by test vector (TV) 226 with a first key K₁ being added to the product, M₁=TV·H+K₁. The hash value H may be any suitable value known to server machine 102 and computing device 150. For example, the hash value H may be derived from session key 220, e.g., by computing a hash of session key 220. In some implementations, hash value H may be a value derived based on an agreed-upon number generated by PRNG 230, e.g., H may be the first (last, etc.) value generated by PRNG 230 or a hash of the first (last, etc.) value generated by PRNG 230. The addition operation may be XOR (modulo 2) bitwise addition. In some implementations, multiplication and addition operations may be modular arithmetic operations. In some implementations, multiplication and addition operations may be defined on Galois fields. In some implementations, multiplication and addition operations may be defined using elliptic curves. The second and all subsequent keys Kⱼ may be processed in a similar manner, Mⱼ=Mⱼ₋₁·H+Kⱼ, until the last key is processed. MAC 232 may be the final value M_{N} or any value derived from M_{N} using one or more additional multiplication, and/or addition operations. Many other procedures for generating the authentication value may be used. In some implementations, generating the authentication value may include applying a suitable hash function Hash(.), e.g., a function that maps an input string of data (e.g., bits) on a fixed-length output string of data. For example, test vector 226 may be concatenated with first key K₁ and the hash function may be applied to the resulting string: M₁=Hash(TV∥K₁). The second and all subsequent keys K₁ may be processed in a similar manner, e.g., Mⱼ=Hash(Mⱼ₋₁∥Kⱼ), until the last key is processed. In some implementations, the hash function Hash(.) may be (or include) a HMAC function. Although in the above examples, a single authentication value jointly authenticates multiple (and, possibly, all) keys K₁ . . . K_{N}, in some implementations, each key Kⱼ may be used to generate a separate MAC 232.

On the computing device 150 side, encrypted session key 212 may be received and decrypted using private update key 206. The decrypted session key 210 may be used to decrypt update instruction 220 and extract seed 224 and test vector 226. Computing device 150 may verify, e.g., using public server key 204, that update instruction 220 is correctly signed by server machine 102. In those implementations, where server machine 102 manages multiple computing devices, computing device 150 may be unable to decrypt update instruction 220 if the update instruction 220 is signed with a private server key 204 assigned to a different computing device (e.g., in the instances where update instruction 220 is accidentally communicated to a wrong target device).

Computing device 150 may execute instruction 220 and perform the update specified therein, which may include installing new software, removing existing software, changing settings of the existing software, adding users, removing users, changing authorization status of users, changing cryptographic keys, and/or performing any other updates. In particular, computing device 150 may then use seed 224 to generate the same set of keys (or any other data values) as generated by server machine 102. The generated keys (and/or any other data values) may be stored in system memory 180, e.g., in a secure portion of system memory 180. More specifically, PRNG 240 may use the same random number-generating algorithm as used by PRNG 230 and, given the same seed 224, may generate the same set of keys 1 . . . N (or any other data values generated by PRNG 230). During a complete decommissioning of computing device 150 or any partial removal of confidential information from computing device 150, PRNG 240 may generate dummy data values that may overwrite any confidential information previously stored on computing device 150, including but not limited to user identifications, passwords, password hashes, confidential logs, access history, settings, financial data, and/or any other information that may be referenced in update instruction 220.

Computing device 150 may also perform the device part of the verification process. More specifically, DSM 190 may read from system memory 180 (e.g., from secure portion of system memory 180) of computing device 150 the data that is referenced in update instruction 220 as being subject to verification (e.g., new keys, new data, dummy values, etc.). The data read from the memory may be processed by MAC computation 250 to obtain a message authentication value, e.g., MAC 252. MAC computation 250 may be performed using the same algorithm as used by server machine 102 to compute MAC 232. Consequently, the same set of keys 1 . . . N (and/or of any other data values) may lead to MAC 252 that is the same as MAC 232. Conversely, if one or more keys 1 . . . N (and/or other data values) differ from the corresponding keys 1 . . . N (and/or other data values) generated by server machine 102, MAC computation 250 may compute MAC 252 that is different from MAC 232.

MAC 252 may be communicated to server machine 102 where MAC verification 260 may compare MAC 252 to MAC 232. For example, MAC verification 260 may include a bitwise XOR circuit (or a corresponding software module). The value of MAC 252⊕MAC 232 that is equal to zero may indicate that the update process has been successful and that the intended data values have been stored in system memory 180 of computing device 150. Any other value MAC 252⊕MAC 232≠0 may indicate that at least one data value has not been properly stored. In those implementations, where each key Kⱼ (or each group of two, three, etc., keys) is used to generate a separate MAC 232, different generated MACs may be communicated to server machine 150 and the determination described above may be performed for each corresponding pair of MACs generated on server machine 102 and computing device 150.

In some implementations, upon determining that the authentication values do not match, MAC verification 260 may cause server machine 102 to generate a new instruction 220 that may include a new seed 224. In some implementations, the new instruction may be encrypted using a new session key 210. The new session key and the new instruction may be communicated to computing device 150 and the update process may be repeated. If the repeated update process results in matching authentication values, the initial error may be attributed to a random error (e.g., a memory write or read error) and no further action may be needed. If the mismatch of the authentication values still persists, MAC verification 260 may flag the remote update failure to a human operator.

Numerous variations of secure updates are within the scope of the present disclosure. In some implementations, public update key 208 may be used by server machine 102 in place of session key 210 to encrypt update instruction 220. Correspondingly, computing device 150 may use private update key 206 to decrypt update instruction 220. In some implementations, MAC 252 may be encrypted before being communicated to server machine 102 over public channel 214, e.g., using public server key 204 or session key 210.

In some systems, MAC 232 (and MAC 252) may be implemented via a public/private key pair. More specifically, to authenticate the data values generated and stored in system memory 180 of computing device 150 in the course of the update session, DSM 190 may digitally sign the data values, using any suitable digital signature algorithm (DSA) such as Elliptic Curve DSA or RSA algorithm using a private key (e.g., private update key 206) whose public key counterpart (e.g., public update key 208) has been previously shared with server machine 102. The server machine 102 can then use the public key to verify the digital signature.

In some implementations, operations of PRNG 240 and MAC computation 250 may be performed by a dedicated hardware accelerator, to speed up the update or decommissioning process. In some implementations, the update process may be initiated by server machine 102 based on the schedule maintained by server machine 102. In some implementations, the update or decommissioning process may be initiated by computing device 150, e.g., upon detecting a security breach or an adversarial attack by an outside entity.

FIG. 2B depicts example operations 201 of a verifiable remote secure update, performed over a secure communication channel 215, in accordance with one or more aspects of the present disclosure. Since the example operations 201 are supported by secure communication channel 215 between server machine 102 and computing device 150, update instruction 220 may be communicated in a plaintext unencrypted form.

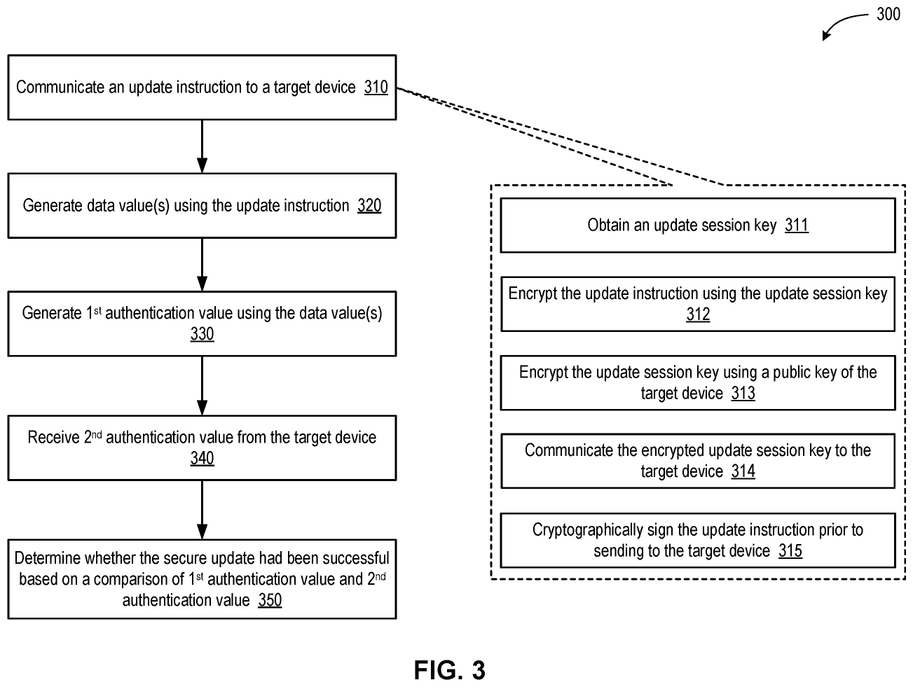

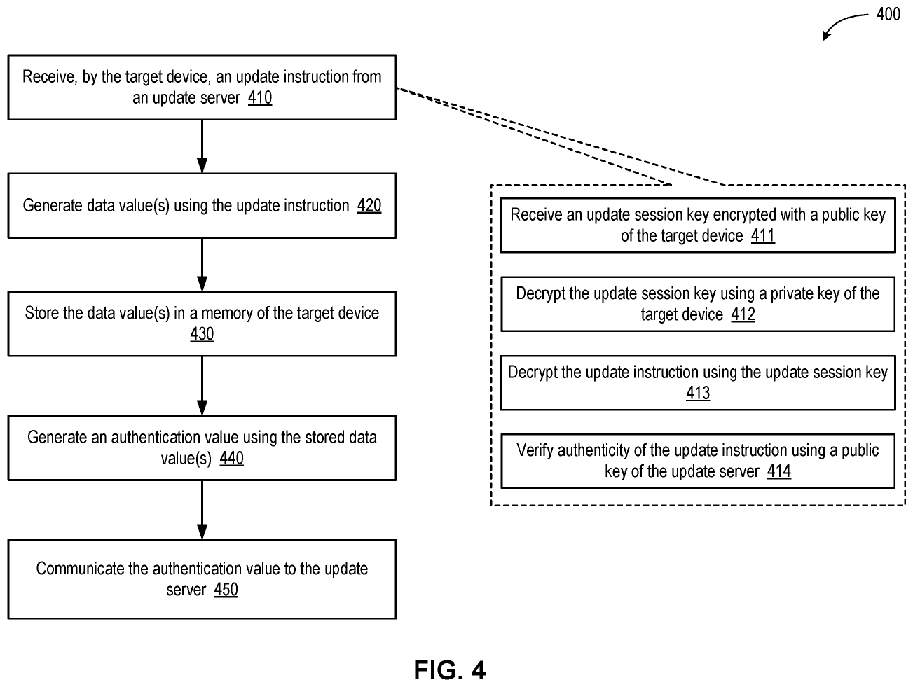

FIG. 3 and FIG. 4 depict flow diagrams of example methods 300 and 400 of performing a remote secure update, in accordance with one or more aspects of the present disclosure. Method 300 and/or method 400 disclosed below, and/or each of their individual functions, routines, subroutines, or operations may be performed by one or more processing units of the computing system implementing the respective methods, e.g., processor 120 of server machine 102 and/or processor 170 of computing device 150. In some implementations, method 300 and/or method 400 may be performed by an arithmetic logic unit, an FPGA, an ASIC, a cryptographic accelerator, a dedicated hardware circuit, and the like, or any processing logic, hardware or software or a combination thereof. In certain implementations, any of methods 300 and 400 may be performed by a single processing thread. Alternatively, any of methods 300 and 400 may be performed by two or more processing threads, each thread executing one or more individual functions, routines, subroutines, or operations of the method. In an illustrative example, the processing threads implementing any of methods 300 and 400 may be synchronized (e.g., using semaphores, critical sections, and/or other thread synchronization mechanisms). Alternatively, the processing threads implementing any of methods 300 and 400 may be executed asynchronously with respect to each other. Various operations of any of methods 300 and 400 may be performed in a different order compared with the order shown in FIG. 3 and FIG. 4. Some blocks may be performed concurrently with other blocks. Some blocks of any of methods 300 and 400 may be optional.

FIG. 3 depicts a flow diagram of an example method 300 of initiating a remote secure update and verifying successful completion of the remote secure update, in accordance with one or more aspects of the present disclosure. Method 300 may be performed by one or more processing units of server machine 102, e.g., processor 120. In some implementations, operations performed by processor 120 may be in response to instructions provided by SCE 140.

Method 300 may involve communicating, at block 310, an update instruction (e.g., update instruction 220 in FIG. 2A) to a target device (e.g., computing device 150). Preparing the update instruction may include a number of operations, illustrated with the callout portion of FIG. 3. In particular, at block 311, method 300 may include obtaining an update session key (e.g., session key 210 in FIG. 2A). In some implementations, the update session key may be an ephemeral key. In some implementations, the update session key may be a symmetric key. At block 312, method 300 may include encrypting the update instruction using the update session key. At block 313, method 300 may continue with encrypting the update session key using a public key of the target device (e.g., public update key 208). At block 314, method 300 may include communicating the encrypted update session key to the target device. At block 315, method 300 may include cryptographically signing the update instruction (e.g., with private server key 202) prior to sending the update instruction to the target device (e.g., by including digital signature 222 into update instruction 220).

At block 320, method 300 may include generating, by a processing device, one or more data values using the update instruction. The data values may be replicas of the data values that are to be stored on the target device and are subject to verification. In some implementations, the one or more data values may include one or more cryptographic keys. In some implementations, the update instruction may include a seed value (e.g., seed value 224) and at least some of the one or more data values are generated by a pseudorandom number generator (e.g., PRNG 230) using the seed value.

At block 330, method 300 may continue with the processing device generating a first authentication value (e.g., MAC 232) using the one or more data values. Generating the first authentication value may be performed using any suitable techniques of computing authentication codes, tags, digital signatures, etc. In some implementations, generating the first authentication value may include applying a hash function to each of the data values. In some implementations, the update instruction may further include a nonce value (e.g., test vector 226), and the first authentication value may be generated using the nonce value (e.g., by using the test vector 226 as the initialization value during computation of the authentication value).

At block 340, method 300 may include receiving a second authentication value from the target device. The second authentication value may be generated by the target device in response to the update instruction and may be based on the same data values as used by server machine to compute the first authentication value at block 320. At block 350, method 300 may include determining whether the secure update has been successful based on a comparison of the first authentication value and the second authentication value. Matching of the first authentication value and the second authentication value may indicate that the secure update has been successful.

FIG. 4 depicts a flow diagram of an example method 400 of performing a secure update based on instruction from a remote device, in accordance with one or more aspects of the present disclosure. Method 400 may be performed by one or more processing units of a target device (e.g., computing device 150), such as processor 170. In some implementations, operations performed by processor 170 may be in response to instructions issued by DSM 190. At block 410, the processing device implementing method 400 may receive, by the target device, an update instruction (e.g., update instruction 220 in FIG. 2A) from an update server (e.g., server machine 102). In some implementations, the update instruction may be encrypted using an update session key (e.g., session key 210). In some implementations, the update session key may be a symmetric key. In some implementations, the update session key may be an ephemeral key. In some implementations, processing the update instruction may include a number of operations, illustrated with the callout portion of FIG. 4. In particular, at block 411, method 400 may include receiving the update session key encrypted with a public key of the target device (e.g., public update key 208). At block 412, method 400 may include decrypting the update session key using a private key of the target device (e.g., private update key 206). At block 413, method 400 may include decrypting the update instruction using the update session key. In some implementations, the update instruction may be cryptographically signed by the update server (e.g., by including signature 222 in update instruction 220) using a private key of the update server (e.g., private server key 202). In some implementations, method 400 may include, at block 414, verifying authenticity of the update instruction using a public key of the update server (e.g., public server key 204).

At block 420, method 400 may continue with the processing device generating one or more data values using the update instruction. In some implementations, the one or more data values may include one or more cryptographic keys. In some implementations, the update instruction may include a seed value (e.g., seed 224) and at least some of the one or more data values may be generated by a pseudorandom number generator (e.g., PRNG 240) using the seed value. It should be understood that the target device may also generate (e.g., install, unpack, etc.) any amount of additional data, e.g., publicly available software or any other public information whose storage in memory of the target device (or removal from the memory of the target device) need not be verified.

At block 430, method 400 may continue with the processing device storing the one or more data values in the memory of the target device. At block 440, method 400 may continue with generating an authentication value using the one or more data values stored in the memory of the target device. More specifically, DSM 190 may read back the stored data values (that are subject to verification, e.g., cryptographic keys and other sensitive data) from the memory of the target device and compute MAC 252 as described above in conjunction with FIG. 2A. In some implementations, generating the authentication value may include applying a hash function to the data values. In some implementations, the update instruction may include a nonce value (e.g., test vector 226) and the authentication value may be generated using the nonce value (e.g., as the initialization value during computation of MAC 252).

In some implementations, e.g., during removal of cryptographic software from the target device or a complete decommissioning of the target device, the data values themselves may be not secret but may replace (in the system memory of the target device) previously used secret keys and other confidential data. At block 450, method 400 may continue with communicating the authentication value to the update server for verification, by the update server (e.g., as described above in conjunction with FIG. 2A and FIG. 3) whether the update process has been successfully performed.

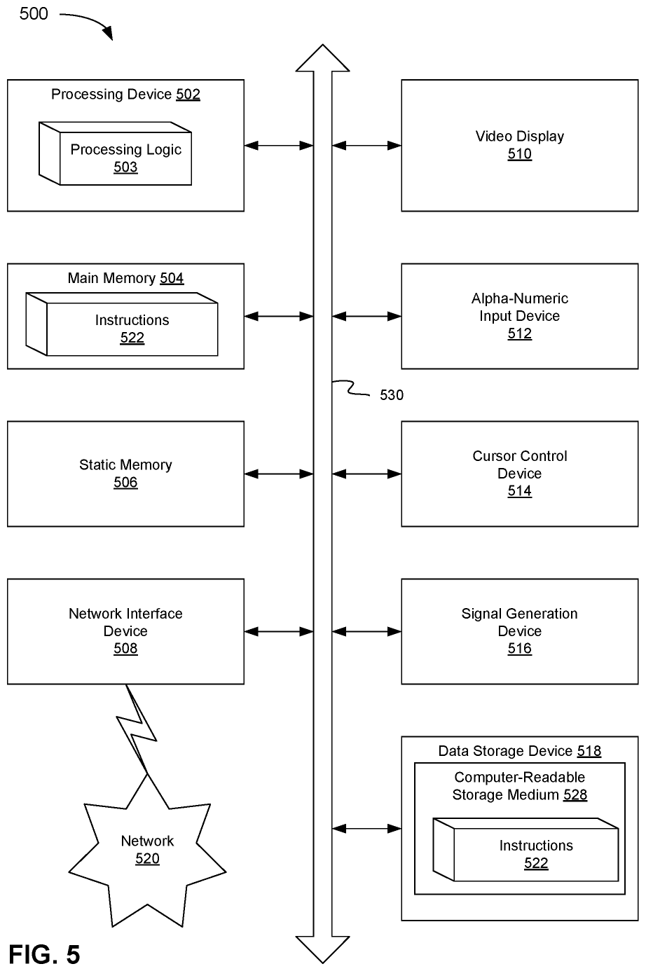

FIG. 5 depicts a block diagram of an example computer system 500 operating in accordance with one or more aspects of the present disclosure. In various illustrative examples, computer system 500 may represent server machine 102 or computer device 150, illustrated in FIG. 1. Example computer system 500 may be connected to other computer systems in a LAN, an intranet, an extranet, and/or the Internet. Computer system 500 may operate in the capacity of a server in a client-server network environment. Computer system 500 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 500 may include a processing device 502 (also referred to as a processor or CPU), which may include processing logic 503, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 518), which may communicate with each other via a bus 530.

Processing device 502 represents one or more general-purpose processing devices such as a microprocessor, central processing unit, or the like. More particularly, processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 502 may be configured to execute instructions implementing method 300 of initiating a remote secure update and verifying successful completion of the remote secure update and method 400 of performing a secure update based on instruction from a remote device.

Example computer system 500 may further comprise a network interface device 508, which may be communicatively coupled to a network 520. Example computer system 500 may further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 516 (e.g., a speaker).

Data storage device 518 may include a computer-readable storage medium (or, more specifically, a non-transitory computer-readable storage medium) 528 on which is stored one or more sets of executable instructions 522. In accordance with one or more aspects of the present disclosure, executable instructions 522 may comprise executable instructions implementing method 300 of initiating a remote secure update and verifying successful completion of the remote secure update and method 400 of performing a secure update based on instruction from a remote device.

Executable instructions 522 may also reside, completely or at least partially, within main memory 504 and/or within processing device 502 during execution thereof by example computer system 500, main memory 504 and processing device 502 also constituting computer-readable storage media. Executable instructions 522 may further be transmitted or received over a network via network interface device 508.

While the computer-readable storage medium 528 is shown in FIG. 5 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method to perform a secure update of a target device, the method comprising:
communicating an update instruction to the target device;
generating one or more data values using the update instruction;
generating a first authentication value using the one or more data values;
receiving a second authentication value from the target device, wherein the second authentication value is generated by the target device in response to the update instruction; and
determining whether the secure update has been successful based on a comparison of the first authentication value and the second authentication value.

2. The method of claim 1, wherein the one or more data values comprise one or more cryptographic keys.

3. The method of claim 1, further comprising:
obtaining an update session key, wherein the update session key is an ephemeral key; and
encrypting the update instruction using the update session key.

4. The method of claim 3, wherein the update session key is a symmetric key.

5. The method of claim 3, further comprising:
encrypting the update session key using a public key of the target device; and
communicating the encrypted update session key to the target device.

6. The method of claim 1, further comprising:
cryptographically signing the update instruction prior to sending the update instruction to the target device.

7. The method of claim 1, wherein the update instruction comprises a seed value, and wherein at least some of the one or more data values are generated by a pseudorandom number generator using the seed value.

8. The method of claim 1, wherein generating the first authentication value comprises applying a hash-based message authentication code to the one or more data values.

9. The method of claim 1, wherein the update instruction further comprises a nonce value, and wherein the first authentication value is generated using the nonce value.

10. A method to perform a secure update of a target device storing one or more cryptographic keys, the method comprising:
receiving, by the target device, an update instruction from an update server;
generating one or more data values using the update instruction;
storing the one or more data values in a memory of the target device;
retrieving the stored data values from the memory;
generating an authentication value using the one or more of the retrieved data values; and
communicating the authentication value to the update server.

11. The method of claim 10, wherein the one or more data values comprise one or more cryptographic keys.

12. The method of claim 10, further comprising:
decrypting the update instruction using an update session key, wherein the update session key is an ephemeral key.

13. The method of claim 12, wherein the update session key is a symmetric key, the method further comprising:
receiving the update session key encrypted with a public key of the target device; and
decrypting the update session key using a private key of the target device.

14. The method of claim 10, wherein the update instruction is cryptographically signed by the update server using a private key of the update server, the method further comprising:
verifying authenticity of the update instruction using a public key of the update server.

15. The method of claim 10, wherein the update instruction comprises a seed value, and wherein at least some the one or more data values are generated by a pseudorandom number generator using the seed value.

16. The method of claim 10, wherein generating the authentication value comprises applying a hash-based message authentication code to the one or more retrieved data values or to hashes of the one or more retrieved data values.

17. The method of claim 10, wherein the update instruction further comprises a nonce value, and wherein the authentication value is generated using the nonce value.

18. A system to perform a cryptographic operation, the system comprising:
a memory device; and
a processing device communicatively coupled to the memory device, the processing device to:
communicate an update instruction to a target device;
generate one or more data values using the update instruction;
generate a first authentication value using the one or more data values;
receive a second authentication value from the target device, wherein the second authentication value is generated by the target device in response a secure update performed by the target device according to the update instruction; and
determine whether the secure update has been successful based on a comparison of the first authentication value and the second authentication value.

19. The system of claim 18, wherein the one or more data values comprise one or more cryptographic keys.

20. The system of claim 18, wherein the processing device is further to:
obtain an update session key;
encrypt the update instruction using the update session key;
encrypt the update session key using a public key of the target device;
communicate the encrypted update session key to the target device; and
cryptographically sign the update instruction prior to sending the update instruction to the target device.
